(19) United States
(12) Patent Application Publication
(10) Pub. No.: US 2010/0288980 A1
(43) Pub. Date: Nov. 18, 2010

(54) PROTECTION OF CARBON NANOTUBES

(75) Inventor: Steven Dale Ittel, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/738,999

(22) PCT Filed: Nov. 14, 2008
(86) PCT No.: PCT/US08/83492

§ 371 Date: Apr. 21, 2010

Related U.S. Application Data
(60) Provisional application No. 60/988,144, filed on Nov. 15, 2007.

(51) Int. Cl. H01B 1/04

(52) U.S. Cl. 252/503; 252/502; 252/506; 252/507; 252/508; 252/509

(57) ABSTRACT

This invention relates to a composition comprising carbon nanotubes and a protective material that protects the carbon nanotubes from damage or degradation such as by oxidation upon exposure to high temperature.

This application claims priority under 35 U.S.C. §119(e) from, and claims the benefit of, U.S. Provisional Application No. 60/988,144, filed Nov. 15, 2007, which is by this reference incorporated in its entirety as a part hereof for all purposes.

### TECHNICAL FIELD

This invention relates to a composition that includes carbon nanotubes and a protective material. The invention further relates to a process for printing the composition and firing it in an oxygen-containing atmosphere, and to devices manufactured by such process.

### BACKGROUND

Carbon nanotubes (“CNTs”) are finding an increasing number of applications in the electronics and materials industries. In a variety of applications, the carbon nanotubes are exposed to an oxygen-containing atmosphere at elevated temperatures during processing, and the exposure to that type of environment is detrimental to the end-use performance of the CNTs. The CNTs may also be exposed to aggressive chemical conditions during their end-use, leading to aging and premature loss of desired properties.

Carbon nanotubes are self-assembling nanostructures derived essentially from graphite sheets rolled up into cylinders [Iijima, Nature, 1991, 354, 56-58]. Such nanostructures are termed single-walled carbon nanotubes (SWNTs) if they are comprised of a single cylindrical tube [Iijima et al, Nature 1993, 363, 603-605; and Bethune et al, Nature 1993, 363, 605-607]. CNTs having two or more concentric tubes are termed double-walled carbon nanotubes (DWNTs) and multi-wall carbon nanotubes (MWNTs), respectively. The diameter of SWNTs of can typically range from about 0.4 nm to 3 nm, and the length from about 10 nm to 0.1 centimeters. CNTs suitable for use herein include without limitation single-wall carbon nanotubes (SWNTs), double-wall carbon nanotubes (DWNTs), multi-wall carbon nanotubes (MWNTs), small diameter carbon nanotubes (SDCNTs, generally having diameters of less than about 3 nm, irrespective of the number of tube walls they possess) and combinations thereof.

CNTs have found use in a wide variety of applications including conductive and high-strength composites, electrode materials for high capacity batteries, efficient field emission displays and radiation sources, and functional nanoscale devices [Baughman et al, Science, 2002, 297, 787-792]. However, the primary barriers to their widespread use remain the high costs involved in their synthesis and particularly their purification. All methods of making CNTs yield product with carbonaceous impurities. Additionally, most methods of making CNTs use metal catalysts or supported metal catalysts that remain in the product as carbon-coated impurities.

The terms “unpurified CNTs” or “raw CNTs” refer generally to a CNT material comprising CNTs and impurities, typically in an as-produced state still in combination with the synthesis catalyst residues and often other forms of carbon. Some synthesis catalyst residues may be catalysts for oxidation or other means of degradation of the CNTs. Other unpurified CNTs include those that have been prepared by laser ablation and contain nickel and cobalt residues from the synthesis catalysts.

SWNTs are currently produced in a variety of ways, including arc discharge, laser furnace ablation (as discussed in U.S. Pat. No. 6,183,714), and chemical vapor deposition (CVD). The HiPco process is a metal catalyzed high pressure carbon monoxide process. While efforts are being made to scale up the production of these materials, all currently known synthesis methods result in large amounts of impurities in the product. For example, carbon-coated metal residues typically comprise 20-30 wt % of CNT materials produced by the HiPco process (Nikolaev et al, Chem. Phys Lett., 1999, 313, 91-97), and about 60 wt % of the product formed in the arc discharge process is non-nanotube carbon.

Compositions incorporating carbon nanotubes are useful in field emission display devices, and methods of manufacturing same, which are discussed in U.S. Ser. No. 02/074,932, U.S. Ser. No. 04/017,141, U.S. Ser. No. 04/169,166, and U.S. Ser. No. 04/170,925, each of which is incorporated in its entirety as a part hereof for all purposes.

Chemically aggressive conditions to which the CNTs may be exposed include exposure to oxygen-containing atmospheres at temperatures greater than 250° C., and the conditions under which field emission display devices are operated. Chemically aggressive conditions could also include exposure to free radical species and intense radiation in the upper atmosphere and outer space.

Carbon nanotubes may experience damaging conditions, for example, in the production and operation of flat panel displays. Flat panel displays having a cathode using a field emission electron source, i.e. a field emission material or field emitter (such as carbon nanotubes), and a phosphor capable of emitting light upon bombardment by electrons emitted by the field emitter, have been proposed. Flat panel displays are manufactured by building up an emitting structure by deposition of the desired materials through a series of high-resolution printing steps onto a substrate. The substrate can be any material to which a paste composition will adhere. If the paste is non-conducting and a non-conducting substrate is used, a film of an electrical conductor to serve as the cathode electrode and provide means to apply a voltage to and supply electrons to the acicular carbon will be needed. Silicon, a glass, a metal or a refractory material such as alumina can serve as the substrate. For display applications, the preferable substrate is glass and soda lime glass is especially preferred. For optimum conductivity on glass, silver paste can be pre-fired onto the glass at 500-550° C. in air or nitrogen, but preferably in air. The conducting layer so-formed can then be over-printed with the emitter paste.

Various processes can be used to attach carbon nanotubes to a substrate to serve as an emissions source in a display as described above. The means of attachment must, however, withstand and maintain its integrity under the conditions of manufacturing the apparatus into which the field emitter cathode is placed and under the conditions surrounding its use, e.g. typically vacuum conditions and temperatures up to about 450° C. Organic materials are generally employed in compositions applicable for attaching the carbon nanotubes together with any oxygen-protective materials to a substrate. A preferred method is to screen print a paste composition containing carbon nanotubes and organic polymers onto a substrate in the desired pattern and to then fire the dried patterned paste. The paste may also contain glass frit, metallic powder or metallic paint or a mixture thereof. For a wide variety of applications, e.g. those requiring finer resolution, the preferred process comprises screen printing a paste which further comprises a photoinitiator and a photohardenable monomer, photo-patterning the dried paste and firing the resulting patterned paste.

A printable composition containing carbon nanotubes is typically suspended in an ink medium. The role of the medium is to suspend and disperse the particulate constituents, i.e. the CNTs and any other solid components, in the paste or ink and provide a proper rheology for typical patterning processes such as screen printing. The medium will normally comprise a polymeric package and a solvent. Examples of polymers that can be used in a printable composition are cellulosic resins such as ethyl cellulose and alkyd resins of various molecular weights. The polymeric package will generally be chosen to be completely soluble in the chosen solvent.

The solvent in the ink medium imparts the necessary fluidity and drying properties to the paste or ink. Butyl carbitol, butyl carbitol acetate, dibutyl carbitol, dibutyl phthalate and terpineol are examples of useful solvents for organic-based systems. Water may also be employed as a solvent. These and other solvents are formulated to obtain the desired viscosity and volatility requirements. A surfactant can be used to improve the dispersion of the particles. Organic acids such oleic and stearic acids and organic phosphates such as lecithin or Gafac® phosphates are typical surfactants. DNA and RNA may be employed as surfactants for CNTs.

If the screen-printed paste is to be photopatterned, the paste contains a photoinitiator, a developable binder and a photohardenable monomer comprised, for example, of at least one addition polymerizable ethylenically unsaturated compound having at least one polymerizable ethylenic group. Photoimagable thick film formulations such as Fodel® paste compositions from DuPont are suitable for this purpose. They contain solids in the form of fine particles and optionally a small amount of low melting glass frit in an organic medium containing photoimagable ingredients such as photoinitiator and photomonomers. Typically, a uniform layer of paste is screen printed on a substrate with controlled thickness. The layer is baked in low heat to dry. A contact photo-mask with the desired pattern is placed in intimate contact with the film and exposed to ultra-violet (UV) radiation. The film is then developed in weak aqueous sodium carbonate. Feature dimensions as small as 10 μm can be produced by photoimaging these screen-printed thick films.

A need thus exists for a protective material that, in a composition with carbon nanotubes, would protect the carbon nanotubes during the exposure of them to aggressive and potentially damaging conditions that result from device manufacture or operation, such as the many conditions described above. It would be particularly useful if the protective material need not be applied as a coating to the carbon nanotubes to provide the desired protection.

### SUMMARY

In one embodiment, this invention provides a composition of matter comprising carbon nanotubes and one or more protective materials wherein the composition has a temperature at the onset of oxidation (as determined by ramped thermogravimetric analysis) that exceeds the temperature at the onset of oxidation of CNTs neat by at least about 5° C.

In another embodiment, this invention provides a composition of matter comprising carbon nanotubes and one or more protective materials wherein a sample of the composition has a mass at the end of isothermal thermogravimetric analysis, conducted for one hour at a temperature in the range of about 350 C to about 450 C, that is at least about 85% of the weight of the sample at the beginning of the test.

In a further embodiment, this invention provides a composition of matter comprising in admixture carbon nanotubes and one or more materials selected from the group of metals consisting of B, Mo, Ta and W; and/or the group of compounds consisting of MoP, MoB₂, WP, WO₃, WO₂, LaB₆, TaN, TaS₂, MoO₃, BC, bismuth glass, AlB₁₂, BN, MgB₂, ZrB₂, TiB₂, AsB₆, CeB₄, YB₁₂, MgB₂, TaB, TaB₂, NbB₂, MoS₂, Sb₂O₃, GeSe₂, Al₂O₃, TiN, GeO₂, MoSi₂, and WS₂.

In yet another embodiment, this invention provides a method of testing materials for the protection of carbon nanotubes.

### BRIEF DESCRIPTION OF THE DRAWINGS

FIG. 1: Illustration of initial tests with thermal ramping: a) Antioxidant protection by molybdenum sulfide; b) Antioxidant protection by tungsten powder; c) No effect demonstrated by WO₃; d) Pro-oxidation demonstrated by NiCoO₂.

FIG. 2: Illustration of secondary isothermal tests: a) molybdenum nanopowder; b) lanthanum hexaboride; tungsten phosphide; d) tungsten nanopowder.

FIG. 3: Performance of protected and unprotected and nitrogen-fired carbon nanotubes emitters: ⋄ Fired in nitrogen atmosphere; ∘ Fired in air with MoS₂ protection; □ Fired in air with no protectant.

### DETAILED DESCRIPTION

There are disclosed herein protective materials one or a combination of which, admixed in a composition with carbon nanotubes, protects the carbon nanotubes during the exposure of them to aggressive and potentially damaging conditions. The protective materials hereof may, for example, impart to carbon nanotubes resistance to oxidation that may occur at elevated temperatures, and may further increase the temperature at which the onset of rapid oxidation of the CNTs occurs. While the invention is not limited to any particular theory of operation, the beneficial effect on CNTs provided by protective materials may relate to the trapping or decomposition of gas-phase radicals in the vicinity of the CNTs, providing a sacrificial material for oxidation in the vicinity of the CNTs, or making the surface of the CNTs more resistant to oxidation.

Protective materials suitable for use in this invention include one or more materials selected from the group of metals consisting of B, Mo, Ta and W; and/or the group of compounds consisting of MoP, MoB₂, WP, WO₃, WO₂, LaB₆, TaN, TaS₂, MoO₃, BC, bismuth glass, AlB₁₂, BN, MgB₂, ZrB₂, TiB₂, AsB₆, CeB₄, YB₁₂, MgB₂, TaB, TaB₂, NbB₂, MoS₂, Sb₂O₃, GeSe₂, Al₂O₃, TiN, GeO₂, MoSi₂, and WS₂. Protective materials as used herein are available commercially from vendors such as Aldrich (Milwaukee, Wis.) or Alpha Aesar (A Johnson Matthey Co. subsidiary, Ward Hill, Mass.).

In alternative embodiments, protective materials suitable for use in this invention include one or more materials selected from the group of metals consisting of B and W; and/or the group of compounds consisting of MoP, MoB₂, WP, WO₃, LaB₆, TaS₂, BC, AlB₁₂, BN, MoS₂, Sb₂O₃ and WS₂.

In further alternative embodiments, protective materials suitable for use in this invention include one or more materials selected from the group of metals consisting of B, Mo, Ta and W; and/or the group of compounds consisting of MoB₂, WP, WO₃, WO₂, LaB₆, TaN, MoO₃, BC, bismuth glass, MoS₂, and MoSi₂.

In further alternative embodiments, protective materials suitable for use in this invention include one or more materials selected from the group of metals consisting of B, Mo, Ta and W; and/or the group of compounds consisting of MoB₂, WP, WO₃, WO₂, LaB₆, TaN, MoO₃, BC, bismuth glass, MoS₂, MoP, TaS₂, AlB₁₂, BN, SbO₃, WS₂, and MoSi₂.

In further alternative embodiments, protective materials suitable for use in this invention include one or more materials selected from the group of metals consisting of B and W; and/or the group of compounds consisting of MoB₂, WP, WO₃, LaB₆, BC, and MoS₂.

A protective material for use herein may be any one or more of all the members of the total group of protective materials disclosed herein. The protective material may also, however, be any one or more of those members of a subgroup of the total group of protective materials disclosed herein, where the subgroup is formed by excluding any one or more other members from the total group. As a result, the protective material in such instance may not only be any one or more of the protective materials in any subgroup of any size that may be selected from the total group of protective materials in all the various different combinations of individual members of the total group, but the members in any subgroup may thus be selected and used in the absence of one or more of the members of the total group that have been excluded to form the subgroup. The subgroup formed by excluding various members from the total group of protective materials may, moreover, be an individual member of the total group such that that protective material is used in the absence of all other members of the total group except the selected individual member.

Protective materials as used herein are used by admixing them with carbon nanotubes in a composition that is deposited or coated on, or is otherwise applied to, a device in which the carbon nanotubes are to be used. For example, the protective materials may be suspended with carbon nanotubes in the type of ink or paste that is used for screen printing, or is otherwise used for patterning, as described above. In a composition of this invention, the composition may contain carbon nanotubes in an amount (in various embodiments) of from about 0.01 wt % to about 30 wt %, or from about 0.01 wt % to about 20 wt %, or from about 0.01 wt % to about 10 wt %, based on the total weight of the composition.

The protective materials disclosed herein are characterized by performance under test conditions that permit classification of them as capable of causing, in a composition of the material(s) with carbon nanotubes, (a) an increase in the temperature at which there is an onset of oxidation, and/or (b) a reduction in the amount of weight lost through oxidation, as compared to the performance under the same conditions of carbon nanotubes neat (i.e. unmixed with a protective material). The classification of the protective materials hereof as causing such an increase of oxidation temperature and/or reduction in weight loss is contrasted with the classification of other materials (not suitable for use herein) that, under the same conditions, (a) impart to the composition little or no increase in oxidation temperature or reduction in weight loss, and/or (b) appear to actually promote oxidation of the CNTs in the composition.

One method of demonstrating the favorable performance of materials suitable for use herein as protective materials, as well as the unfavorable performance of materials that are not suitable for use herein, involves the use of thermogravimetric analysis (“TGA”), such as ramped or isothermal TGA. TGA is a technique that is known in the art and is described in ASTM standards, such as E2008-08 and E2402-05. TGA for such purpose may carried out, for example, on a Hi-Res TGA 2950 Thermogravimetric Analyzer obtainable from TA Instruments—Waters LLC (109 Lukens Drive, New Castle Del. 19720), including analysis of the results obtained using TA Instruments' software—“Universal Analysis 2000” Software (Version 3.88).

When a composition of carbon nanotubes and a protective material is analyzed by TGA, the sample may, for example, contain about 25 wt % CNTs and about 75 wt % protective material. The analysis may be run in air or a selected gas, and the temperature profile may, for example, be started at room temperature (e.g. about 25° C.), and the temperature of the sample may then be ramped to about 500° C. at about 10° C./min. With software, a line may be drawn tangent to the initial weight and a second line may be drawn tangent to the slope of the curve after the onset of rapid weight loss. The intersection of these two lines may be taken as the temperature of the onset of oxidation. The temperature for the onset of oxidation of CNTs neat may then be subtracted from the temperature for the onset of oxidation for the composition of CNTs and protective material. Where the sample to be tested shows a small initial weight loss due to the drying of absorbed moisture, a correction is made for this by taking the initial weight to be the weight at 200° C., and all subsequent weights are referenced to that weight.

When tested by ramped TGA in the manner described above, a composition containing a protective material as used herein may have a temperature at the onset of oxidation that (in various embodiments) exceeds the temperature at the onset of oxidation of CNTs neat by at least about 5° C., or by at least about 10° C., or by at least about 15° C., or by at least about 20° C., or by at least about 25° C.

Alternatively, when a composition of carbon nanotubes and a protective material is analyzed by ramped TGA, the sample may, for example, contain about 25 wt % CNTs and about 75 wt % protective material. The analysis may be run in air or a selected gas, and the temperature profile may, for example, be started at room temperature (e.g. about 25° C.), and the temperature of the sample may then be ramped to about 500° C. at about 10° C./min. The inflection point of the resulting graphical representation of the temperature curve is recorded, as is the final percent weight retention between 200° C. and 450° C. A composition CNTs and a protective material as used herein may have an inflection point of about 350° C. or higher, and a final weight retention between about 200° C. and about 450° C. (in various embodiments) of greater than about 85%, or greater than about 90%, or greater than about 95%, or greater than about 98%.

Alternatively, when a composition of carbon nanotubes and a protective material is analyzed by TGA, the sample may, for example, contain about 25 wt % CNTs and about 75 wt % protective material. The analysis may be run in air or a selected gas, and the temperature profile may, for example, be started at room temperature, and the temperature of the sample may then be ramped to a selected temperature as rapidly as possible(at a rate, e.g., of about 200° C./min), and the amount of weight loss that the sample experiences over a period of 60 minutes at that temperature is then determined. The selected temperature for the measurement of isothermal weight loss may, for example, be a temperature that is elevated to a level where oxidation is probable, such as about 350° C. or more, about 400° C. or more, about 425° C. or more, or about 450° C. or more. Before running the test as described above, it may be necessary to perform an isothermal TGA for one hour at the same selected temperature on the protective material to determine and appropriately correct for any mass changes attributable to the protective material itself.

When tested at a selected temperature by isothermal TGA in the manner described above, a composition containing a protective material as used herein may have a mass at the end of the test that is (in various embodiments) at least about 85%, or at least about 90%, or at least about 95%, or at least about 98% of the weight of the sample at the beginning of the test.

In general, a weight loss of 25% or more indicates complete loss of the carbon nanotubes, but in some instances the protective material may retain some water, and an initial weight loss before 200° C. is thus generally observed. This is factored into the analysis. Some candidate inorganic oxidative protection additives could actually be oxidized, and the weight would rise if the oxygen is retained, or decrease further if some fraction of the candidate material is lost as a gas-phase species. These effects are generally obvious. Finally, there may be several instances in which weight loss is instantaneous; this is generally an indication of combustion with an actual flame rather than smooth, continuous oxidation.

The compositions hereof are useful in a cathode assembly, a triode assembly and/or a field emission device, and methods of manufacturing same, which are discussed in U.S. Ser. No. 02/074,932, U.S. Ser. No. 04/017,141, U.S. Ser. No. 04/169,166, and U.S. Ser. No. 04/170,925, each of which is incorporated in its entirety as a part hereof for all purposes. A cathode assembly may contain, in no particular order, a substrate, a cathode electrode, an electron field emitter, and a charge dissipation layer. A triode assembly may contain a gate electrode in addition to the same elements as a cathode assembly. A field emission device contains a cathode assembly or triode assembly and an anode assembly where an anode assembly may contain a substrate, an anode electrode and a phosphor layer. A composition of this invention may serve as an electron field emitter as it contains an electron emitting material, CNTs.

### Examples

The following examples are provided to demonstrate particular embodiments of this invention, and the invention is not in any way limited to these examples. It should be appreciated that the methods disclosed in the following examples merely represent exemplary embodiments of this invention, and many changes can be made in the specific embodiments described herein while still obtaining a like or similar result without departing from the spirit and scope of this invention.

### General Procedure

Carbon nanotubes prepared by furnace laser ablation according to U.S. Pat. No. 6,183,714 were comminuted with candidate protective materials purchased from Aldrich (Milwaukee, Wis.) or Alpha Aesar (A Johnson Matthey Co. subsidiary, Ward Hill, Mass.). The candidate protective material was comminuted in a laboratory mill [CertiPrep 5100 Mixer/Mill, SPEX, LLC (Metuchen, N.J.)]. Carbon nanotubes (approximately 25 mg) were added to the 2 mL stainless steel grinding vial and then approximately 75 mg of the candidate protective material were added, followed by a 7 mm stainless steel grinding ball. The vessel was capped and sealed with electrical tape before placing in the compact laboratory mill for 5 min. The pulverized sample was then analyzed by thermogravimetric analysis.

The thermogravimetric analysis was carried out on a Hi-Res TGA 2950 Thermogravimetric Analyzer (TA Instruments—Waters LLC, 109 Lukens Drive, New Castle, Del. 19720). Analysis of the results was carried out using TA Instruments' software (“Universal Analysis 2000” Software, Version 3.88). A sample of approximately 2-15 mg in size was weighed into an open platinum pan. The analyses were run in air with a gas flow of 40 ml/min. Analyses were started at room temperature and ramped to 500° C. at 10° C./min. Many of the samples showed a small initial weight loss due to drying of absorbed moisture. To correct for this, the initial weight was taken to be the weight at 200° C., and all subsequent weights were referenced to that weight. The software available with the instrument was used to draw a line tangent to the initial weight and to draw a second line tangent to the slope of the curve after the onset of rapid weight loss. The intersection of these two lines was taken as the temperature of the onset of oxidation. The temperature for the onset of oxidation of the pure nanotubes was subtracted from the temperature for the onset of oxidation for the comminuted mixture of nanotubes with the candidate protective material. The Protection Index was then calculated by subtracting the onset temperature of the pure nanotubes from the onset temperature of the communited mixture. Values for the PI of greater than 5 were considered to be desirable; PI values of greater than 20 were preferred.

Those samples that gave a PI of greater than 5 were said to have conferred protection to the CNTs. Those samples that gave negative PI values are pro-oxidants, actually making the CNTs more prone to oxidation. Compounds in this class included iron, cobalt and nickel oxides, that can be found in catalyst residues. They also included Ag, SnO₂, TiO₂, V₂O₅, Cr₂O₃, Fe₂O₃, NiCoO₂, NiO, CuO, SiO₂, PdO, PtO₂, PbO₂ and RuO₂.

In general, a weight loss of 25% indicated complete loss of the carbon nanotubes, but there were additional factors to be considered. If the candidate inorganic oxidative protection additive had retained some water, an initial weight loss before 200° C. was generally observed. This was factored into the analysis. Some candidate inorganic oxidative protection additives could actually be oxidized and the weight would rise if the oxygen was retained or decrease further if some fraction of the candidate material was lost as a gas-phase species. These effects were generally obvious. Finally, there were several instances in which weight loss would be instantaneous; this was generally an indication of combustion with an actual flame rather than smooth, continuous oxidation.

### Example 1

### Initial Evaluation of Molybdenum Sulfide

Carbon nanotubes (25 mg) prepared by furnace laser ablation were combined with molybdenum sulfide (75 mg, Alfa Aesar, Lot #100935, [1317-33-5], FW 160.08). The mixture was placed in the 2 mL stainless steel grinding vial of a laboratory mill [CertiPrep 5100 Mixer/Mill, SPEX, LLC (Metuchen, N.J.)] with a 7 mm stainless steel grinding ball. The vessel was capped and sealed with electrical tape before milling for 5 min. The thoroughly mixed, pulverized sample was then analyzed by thermogravimetric analysis.

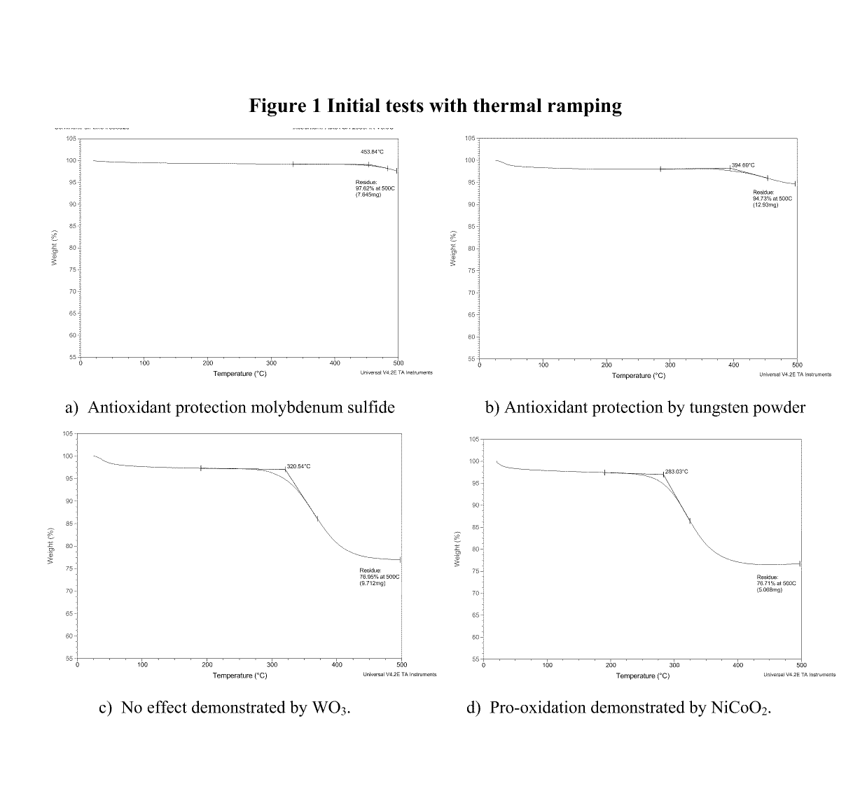

The thermogravimetric analysis was carried out on a Hi-Res TGA 2950 Thermogravimetric Analyzer. Analysis of the results was carried out using TA Instruments' software. A sample of approximately 2-15 mg in size was weighed into an open platinum pan. The analyses were run in air with a gas flow of 40 ml/min. Analyses were started at anbient temperature and ramped to 500° C. at 10° C./min. The thermal trace is shown in FIG. 1A. The onset of oxidation took place at 454° C., well above the 320° C. observed with unprotected carbon nanotubes. Thus this molybdenum sulfide was deemed to have provided protection to the CNTs.

### Example 2

### Initial Evaluation of many Samples

Other compounds evaluated by this method are enumerated in Table 1. The correction for sample drying causes all masses to be 100% at 200° C. The control sample of carbon nanotubes with no additive is shown in the middle of the table, and compounds immediately above or below it are not statistically different than the control. Illustrative examples shown in FIG. 1 demonstrate the range of observed behaviors. FIG. 1A is molybdenum sulfide, a useful protective material, as discussed above in Example 1. FIG. 1B illustrates the protective effect of tungsten powder. FIG. 1C illustrates that tungsten oxide displays essentially no effect. FIG. 1D illustrates that NiCoO₂ is a pro-oxidant, causing the early onset of oxidation.

TABLE 1
Temperature of onset of oxidation and the Protection
Index (“PI”) of selected materials showing
protectants, pro-oxidants and materials between.

| | Inflection | |
|---|---|---|
| Compound | temp (° C.) | PI |
| MoS₂ | 454 | 135 |
| B | 425 | 106 |
| TaS₂ | 414 | 95 |
| WS₂ micro | 404 | 85 |
| WP | 397 | 78 |
| W nano | 394 | 75 |
| WO₃ nano | 392 | 73 |
| WS₂ | 391 | 72 |
| AlB₁₂ | 380 | 61 |
| MoP | 380 | 61 |
| Sb₂O₃ | 376 | 57 |
| BN | 376 | 57 |
| LaB₆ | 373 | 54 |
| MoB₂ | 372 | 53 |
| BC | 364 | 45 |
| MoS₂ nano | 351 | 32 |
| GeSe₂ | 350 | 31 |
| Mo nano | 349 | 30 |
| MoO₃ | 346 | 27 |
| WO₂ | 343 | 24 |
| TaN | 341 | 22 |
| Al₂O₃ Fumed | 340 | 21 |
| TiN | 337 | 18 |
| GeO₂ | 328 | 9 |
| Bi Frit | 322 | 3 |
| MoSi₂ | 321 | 2 |
| WO₃ | 320 | 1 |
| PtO₂ | 320 | 1 |
| Control | 319 | 0 |
| TiO₂ fumed | 319 | 0 |
| Ta nano | 316 | −3 |
| WC | 315 | −4 |
| AlN | 313 | −6 |
| SnO₂ nano | 312 | −7 |
| NbP | 310 | −9 |
| NbO | 310 | −9 |
| Lead frit | 309 | −10 |
| TiSi | 308 | −11 |
| ATO | 307 | −12 |
| TiC | 306 | −13 |
| Al₂O₃ | 307 | −12 |
| CuZnFe₂O₅ | 305 | −14 |
| TiO₂ | 304 | −15 |
| ZnTiO₃ | 304 | −15 |
| SiO₂ Aerosil | 304 | −15 |
| Attapulgite | 304 | −15 |
| Bi₂O₃ | 301 | −18 |
| ITO | 300 | −19 |
| SiO₂ Fumed | 298 | −21 |
| In₂O₃ | 293 | −26 |
| PdO | 293 | −26 |
| V₂O₅ | 292 | −27 |
| Fe₂O₃ | 291 | −28 |
| Ce₃ZrO₈ | 289 | −30 |
| Ag nano | 287 | −32 |
| BaFe₂O₄ | 287 | −32 |
| BaTiO₃ | 286 | −33 |
| Cr₂O₃ | 285 | −34 |
| Sn powder | 285 | −34 |
| NiO | 284 | −35 |
| NiCoO₂ | 283 | −36 |
| Fe₂NiO₄ | 283 | −36 |
| CuO | 264 | −55 |
| RuO₂ | 262 | −57 |
| Ag Nano | 239 | −80 |

### Example 3

### Initial Evaluation of Mixed Protectants

To test the efficacy of combinations of protective materials, premixed samples of carbon nanotubes with AlB₁₂ and AlN from the tests shown in Table 1 were combined and mixed thoroughly. The sample was then tested in the same manner and showed an onset of oxidation at 400° C. This is an improvement over either of the individuals that were found to be at 380° C. and 376° C. for AlB₁₂ and AlN, respectively.

### General Procedure for Secondary Isothermal Evaluation

Those samples that were promising in the screening method described above were subjected to a secondary test. In the secondary test, the milled samples from the preliminary screen were again tested by TGA. The sample is heated as rapidly as possible (about 200° C./min) to the desired temperature, and then the mass was monitored as a function of time at that temperature for a period of one hour. These experiments were carried out at 350° C., 400° C., 425° C. and 450° C. Percent weight loss indicated the rate of oxidation at each of those temperatures. Some protective materials conferred oxidative stability at all of the temperatures while others conferred stability at only some of the lower temperatures. There were several interesting cases in which the mass actually increased as the protective material slowly oxidized. For those materials, control tests were run on the protective materials with no carbon nanotubes so that the two rates of oxidation with and without nanotubes could be compared to assure that there was no underlying CNT oxidation. Samples were said to have passed this test if at least half of the carbon nanotubes survived the heating for one hour.

### Example 4

### Secondary Isothermal Evaluation of Molybdenum Nanopowder

Carbon nanotubes (25 mg) prepared by furnace laser ablation were combined with molybdenum nanopowder (75 mg, Aldrich Catalog No. 577987-5 g, <100 nm). The mixture was placed in the 2 mL stainless steel grinding vial of a laboratory mill [CertiPrep 5100 Mixer/Mill, SPEX, LLC (Metuchen, N.J.)] with a 7 mm stainless steel grinding ball. The vessel was capped and sealed with electrical tape before milling for 5 min. The thoroughly mixed, pulverized sample was then analyzed by thermogravimetric analysis.

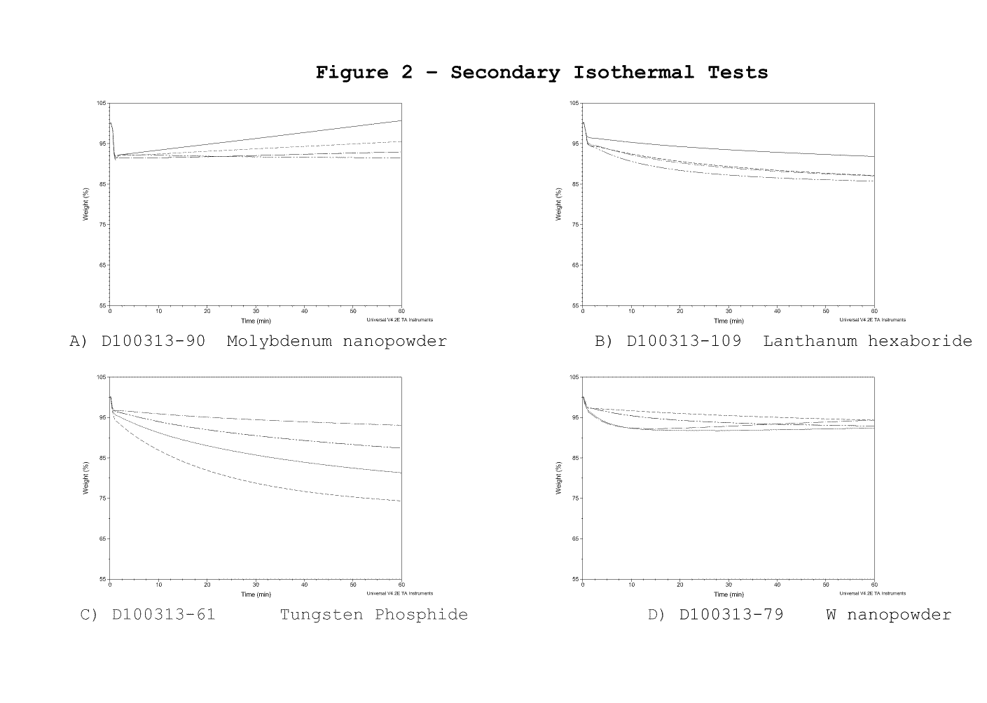

The thermogravimetric analysis was carried out on a Hi-Res TGA 2950 Thermogravimetric Analyzer. Analysis of the results was carried out using TA Instruments' software. Four different samples of approximately 2-15 mg in size were weighed into open platinum pans. The analyses were run in air with a gas flow of 40 ml/min. Analyses were started at room temperature (about 25° C.) and ramped to 350° C. as rapidly as possible, and the percent weight loss was then monitored over a period of 60 minutes at that temperature. Separate samples were analyzed similarly at 400° C., 425° C. and 450° C. The thermal traces are shown in FIG. 2A. After the initial weight loss during the ramping process, the weight was virtually unchanged over an hour at 350° C. and 400° C., with an increase of 3% at 425° C., and an increase in mass of 8% at 450° C. Thus the molybdenum nanopowder was deemed to have provided protection to the CNTs.

### Example 5

### Secondary Evaluation of many Samples

Other compounds deemed to be protective in the initial screen and evaluated by the secondary method are enumerated in Table 2. Note that under one or more conditions, the first five samples actually increased in mass, indicating that the protective material was undergoing some oxidation. Thus the first compound, molybdenum silicide, was at least partially oxidized to molybdenum oxide and silicon dioxide. Sacrificial oxidation of another material is a means of protecting carbon nanotubes from oxidation. The correction for sample drying causes all masses to be 100% at the initial weight at 350° C. (350-I).

The control sample of carbon nanotubes with no additive is shown in the middle of the table and compounds immediately above or below it are not statistically different than the control. Illustrative examples shown in FIG. 2 demonstrate the range of observed behaviors. FIG. 2A is molybdenum nanopowder, a good protective material from Example 3. FIG. 2B illustrates the protective effect of lanthanum hexaboride where there are only slight decreases in the mass at all temperatures. FIG. 2C illustrates that tungsten phosphide is protective at 350° C. with decreasing effectiveness at higher temperatures such that all carbon nanotubes are gone after 1 hour at 450° C. FIG. 2D illustrates that tungsten nanopowder affords some protection at 350° C. and 400° C., but that at higher temperatures, there is a relatively rapid initial drop in weight that is masked by subsequent oxidation and weight gain of the tungsten nanopowder.

TABLE 2
Sustained Protection Index for a variety of compounds at four
different temperatures (showing percent weight loss).

| Compound | SPI₃₅₀ | SPI₄₀₀ | SPI₄₂₅ | SPI₄₅₀ |
|---|---|---|---|---|
| MoSi2 | 5 | 0 | −20 | −28 |
| B | −2 | −3 | −5 | −13 |
| Mo nano | 1 | 0 | −3 | −8 |
| Ta nano | 1 | −2 | −5 | −7 |
| MoB | 3 | 5 | 3 | −1 |
| W nano | 2 | 4 | 5 | 3 |
| TaN | 2 | 6 | 7 | 7 |
| MoO3 | 5 | 9 | 7 | 8 |
| LaB6 | 3 | 9 | 9 | 10 |
| BC | 3 | 10 | 11 | 11 |
| WO2 | 5 | 9 | 11 | 12 |
| WO3 nano | 3 | 8 | 11 | 13 |
| Bi frit | 6 | 11 | 11 | 13 |
| MoS2 | 2 | 8 | 11 | 13 |
| MoP | 5 | 13 | 14 | 14 |
| AlB12 | 3 | 9 | 17 | 15 |
| Sb2O3 | 4 | 13 | 15 | 16 |
| TaS2 | 3 | 11 | 16 | 16 |
| BN | 5 | 16 | 15 | 19 |
| Pb frit | 18 | 19 | 19 | 19 |
| WS2 | 3 | 14 | 18 | 20 |
| WS2 | 3 | 15 | 17 | 22 |
| WP | 3 | 10 | 16 | 23 |
| Ag nano | 26 | 26 | 26 | 26 |
| Al2O3 | 13 | 25 | 34 | 31 |

### General Method for Evaluating Oxidative Protection in a Field Emission Device

Field emission tests were carried out on the resulting samples using a flat-plate emission measurement unit comprised of two electrodes, one serving as the anode or collector and the other serving as the cathode. The cathode consists of a copper block mounted in a polytetrafluoroethylene (PTFE) holder. The copper block is recessed in a 1 inch by 1 inch (2.5 cm×2.5 cm) area of PTFE and the sample substrate is mounted to the copper block with electrical contact being made between the copper block and the sample substrate by means of copper tape. A high voltage lead is attached to the copper block. The anode is held parallel to the sample at a distance, which can be varied, but once chosen it was held fixed for a given set of measurements on a sample. Unless stated otherwise was a spacing of 1.25 mm was used. The anode consists of a glass plate coated with indium tin oxide deposited by chemical vapor deposition. It is then coated with a standard ZnS-based phosphor, Phosphor P-31, Type 139 obtained from Electronic Space Products International. An electrode is attached to the indium tin oxide coating.

The test apparatus is inserted into a vacuum system, and the system was evacuated to a base pressure below 1×10⁻⁵ torr (1.3×10⁻³ Pa). A negative voltage pulse with typical pulse width of 3 μsec at a frequency of 60 Hz is applied to the cathode and the emission current was measured as a function of the applied voltage. The image emitted by the phosphor as a result of the emission current is recorded with a camera.

### Example 6

### Evaluating Oxidative Protection in a Field Emission Device Protected with Molybdenum Sulfide

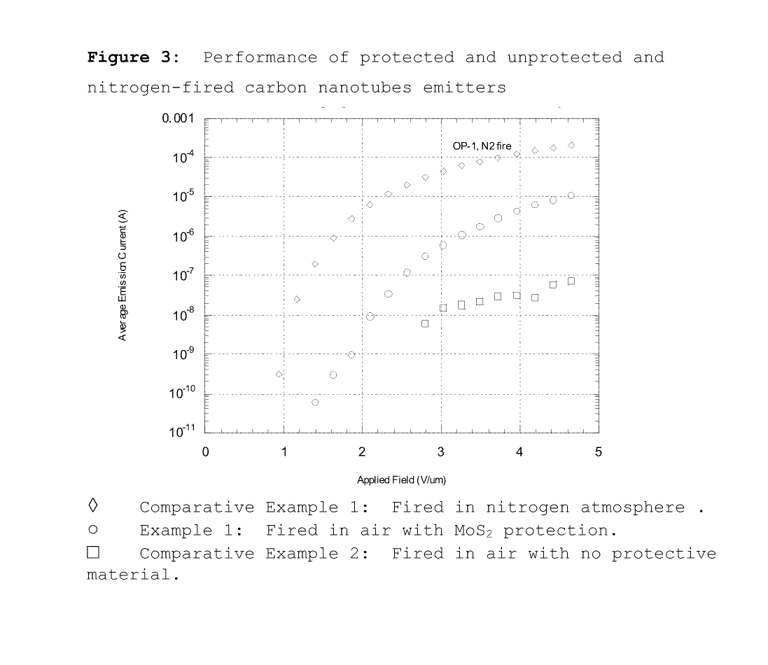

Carbon nanotubes prepared by furnace laser ablation were investigated under three different conditions. Emission current as a function of applied voltage was measured for three samples. All were measured at 1/1000 duty cycle. All three were fired at 420° C. in a belt furnace and then tape activated. The results are shown in FIG. 3. The top curve is the unprotected material fired in a nitrogen atmosphere and represents optimal performance of the system. The bottom curve is the same sample fired at 420° C. in air rather than nitrogen. Emission is down significantly due to oxidation of the carbon nanotubes. The middle curve is the same material but containing molybdenum sulfide nanoparticles fired at 420° C. in air. Emission is reduced from the sample fired in nitrogen but significantly better than the sample fired in air without molybdenum sulfide.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, amounts, sizes, ranges, formulations, parameters, and other quantities and characteristics recited herein, particularly when modified by the term “about”, may but need not be exact, and may also be approximate and/or larger or smaller (as desired) than stated, reflecting tolerances, conversion factors, rounding off, measurement error and the like, as well as the inclusion within a stated value of those values outside it that have, within the context of this invention, functional and/or operable equivalence to the stated value.

What is claimed is:

1. A composition of matter comprising carbon nanotubes and one or more protective materials wherein the composition has a temperature at the onset of oxidation (as determined by ramped thermogravimetric analysis) that exceeds the temperature at the onset of oxidation of CNTs neat by at least about 5° C.

2. A composition according to claim 1 wherein the composition comprises carbon nanotubes in an amount of from about 0.01 wt % to about 20 wt % based on the total weight of the composition.

3. A composition according to claim 1 that further comprises one or more of a polymer, a solvent, a photoinitiator, a binder, a photohardenable monomer, a photoacid generator and an acid solubilization component.

4. A composition according to claim 1 in the form of a printable paste or ink.

5. A composition according to claim 1 wherein a sample of the composition has a mass at the end of isothermal thermogravimetric analysis conducted for one hour at a temperature in the range of about 350° C. to about 450° C. that is at least about 85% of the weight of the sample at the beginning of the test.

6. A composition according to claim 1 wherein the protective material comprises one or more materials selected from the group of metals consisting of B, Mo, Ta and W; and/or the group of compounds consisting of MoP, MoB₂, WP, WO₃, WO₂, LaB₆, TaN, TaS₂, MoO₃, BC, bismuth glass, AlB₁₂, BN, Ta, MgB₂, ZrB₂, TiB₂, AsB₆, CeB₄, YB₁₂, MgB₂, TaB, TaB₂, NbB₂, MoS₂, and WS₂.

7. A composition according to claim 1 wherein the protective material comprises one or more materials selected from the group of metals consisting of B, Mo, Ta and W; and/or the group of compounds consisting of MoB₂, WP, WO₃, WO₂, LaB₆, TaN, MoO₃, BC, bismuth glass, MoS₂, MoP, TaS₂, AlB₁₂, BN, SbO₃, WS₂, and MoSi₂.

8. A cathode assembly, triode assembly or electron field emitter comprising a composition according to claim 1.

9. A composition of matter comprising carbon nanotubes and one or more protective materials wherein a sample of the composition has a mass at the end of isothermal thermogravimetric analysis, conducted for one hour at a temperature in the range of about 350° C. to about 450° C., that is at least about 85% of the weight of the sample at the beginning of the test.

10. A composition of matter comprising in admixture carbon nanotubes and one or more materials selected from the group of metals consisting of B, Mo, Ta and W; and/or the group of compounds consisting of MoP, MoB₂, WP, WO₃, WO₂, LaB₆, TaN, TaS₂, MoO₃, BC, bismuth glass, AlB₁₂, BN, Ta, MgB₂, ZrB₂, TiB₂, AsB₆, CeB₄, YB₁₂, MgB₂, TaB, TaB₂, NbB₂, MoS₂, and WS₂.
